(19) United States
(12) Patent Application Publication
(10) Pub. No.: US 2017/0350320 A1
(43) Pub. Date: Dec. 7, 2017

(54) System for Cooling Exhaust Gas with Absorption Chiller

(71) Applicant: General Electric Company, Schenectady, NY (US)

(72) Inventors: Bradly Aaron Kippel, Greenville, SC (US); Hua Zhang, Greenville, SC (US)

(21) Appl. No.: 15/176,132

(22) Filed: Jun. 7, 2016

(51) Int. Cl. F02C 7/18; F01D 25/12; F01N 3/20; F01N 5/02; F01N 9/00; F01N 3/08

(52) U.S. Cl. CPC F02C 7/185; F01N 9/00; F01N 3/0842; F01N 3/206; F01N 3/2066; F01N 5/02; F01D 25/12; F01N 2240/02; F01N 2270/02; F01N 2560/06; F01N 2570/14; F01N 2610/02

(57) ABSTRACT

A gas turbine system includes a gas turbine engine configured to combust a fuel and produce an exhaust gas. An exhaust duct assembly is coupled to the gas turbine engine and is configured to receive the exhaust gas. An absorption chiller is fluidly coupled to the exhaust duct assembly and is configured to receive a take-off stream of the exhaust gas. The absorption chiller is configured to use the take-off stream to drive at least a portion of an absorption cooling process to generate a cooled take-off stream of exhaust gas. The exhaust duct assembly is configured to receive the cooled take-off stream of exhaust gas from the absorption chiller and to mix the cooled take-off stream with exhaust gas present within the exhaust duct assembly to cool the exhaust gas.

### BACKGROUND OF THE INVENTION

The subject matter disclosed herein relates to turbine systems and, more specifically, to systems and methods for injecting cooling air into exhaust gas flow(s) produced by turbine systems.

Gas turbine systems typically include at least one gas turbine engine having a compressor, a combustor, and a turbine. The combustor is configured to combust a mixture of fuel and compressed air to generate hot combustion gases, which, in turn, drive blades of the turbine. Exhaust gas produced by the gas turbine engine may include certain byproducts, such as nitrogen oxides (NOₓ), sulfur oxides (SOₓ), carbon oxides (COₓ), and unburned hydrocarbons.

### BRIEF DESCRIPTION OF THE INVENTION

In one embodiment, a gas turbine system includes a gas turbine engine configured to combust a fuel and produce an exhaust gas. An exhaust duct assembly is fluidly coupled to the gas turbine engine and is configured to receive the exhaust gas from the gas turbine engine. An absorption chiller is fluidly coupled to the exhaust duct assembly and is configured to receive a take-off stream of exhaust gas from the exhaust duct assembly via an exhaust take-off path. The absorption chiller is configured to use the take-off stream of exhaust gas to drive at least a portion of an absorption cooling process to generate a cooled take-off stream of exhaust gas. The exhaust duct assembly is configured to receive the cooled take-off stream of exhaust gas from the absorption chiller via a cooled take-off path and to mix the cooled take-off stream of exhaust gas with exhaust gas present within the exhaust duct assembly to cool the exhaust gas.

In another embodiment, a system includes an exhaust duct assembly fluidly configured to receive exhaust gas from a gas turbine engine and an absorption chiller fluidly coupled to the exhaust duct assembly and configured to receive a take-off stream of exhaust gas from the exhaust duct assembly via an exhaust take-off path. The absorption chiller is configured to use the take-off stream of exhaust gas to drive at least a portion of an absorption cooling process to generate a cooled take-off stream of exhaust gas. The system also includes a heat exchanger fluidly coupled to the absorption chiller via a chilled fluid path configured to flow a stream of chilled fluid from the absorption chiller to the heat exchanger. The heat exchanger is positioned within the exhaust duct assembly or is part of a tempering air injection system configured to provide tempering air to the exhaust duct assembly.

In a further embodiment, a gas turbine system is provided. The system includes a gas turbine engine configured to combust a fuel and produce an exhaust gas; an exhaust duct assembly fluidly coupled to the gas turbine engine and configured to receive the exhaust gas from the gas turbine engine. The exhaust duct assembly is configured to flow the exhaust gas along an exhaust gas path from an inlet to an outlet. The system also includes a selective catalytic reduction (SCR) system having an SCR catalyst positioned within the exhaust duct assembly and an ammonia injection grid positioned within the exhaust duct assembly upstream of the SCR catalyst. The ammonia injection grid is configured to inject ammonia into the exhaust gas path and the SCR catalyst is configured to reduce an amount of NOₓ present within the exhaust gas. An absorption chiller is fluidly coupled to the exhaust duct assembly and configured to receive a take-off stream of exhaust gas from the exhaust duct assembly via an exhaust take-off path. The absorption chiller is configured to use the take-off stream of exhaust gas to drive at least a portion of an absorption cooling process to generate a cooled take-off stream of exhaust gas. The exhaust duct assembly is configured to receive the cooled take-off stream of exhaust gas from the absorption chiller via a cooled take-off path and to mix the cooled take-off stream of exhaust gas with exhaust gas along the exhaust flow path to cool the exhaust gas. The system further includes a control system configured to control cooling of the exhaust gas along the exhaust gas path such that a temperature of the exhaust gas, upon encountering the SCR catalyst, is within a predetermined temperature range that is appropriate for the SCR catalyst to reduce the amount of NOₓ present within the exhaust gas.

### BRIEF DESCRIPTION OF THE DRAWINGS

These and other features, aspects, and advantages of the present invention will become better understood when the following detailed description is read with reference to the accompanying drawings in which like characters represent like parts throughout the drawings, wherein:

FIG. 1 is a schematic side view of an embodiment of a simple cycle gas turbine system having an exhaust processing system that utilizes an absorption chiller driven by an exhaust gas take-off stream to simultaneously cool exhaust gas generated by the system and to produce cooled tempering air for further cooling of the exhaust gas, in accordance with an aspect of the present disclosure;

FIG. 2 is a schematic side view of another embodiment of the simple cycle gas turbine system of FIG. 1 in which the exhaust gas take-off stream is downstream of a tempering air injection grid, in accordance with an aspect of the present disclosure;

FIG. 3 is a schematic side view of an embodiment of a simple cycle gas turbine system having an exhaust processing system that utilizes an absorption chiller driven by an exhaust gas take-off stream to simultaneously cool exhaust gas generated by the system and to direct a chilled fluid stream to an exhaust gas heat exchanger for further cooling of the exhaust gas, in accordance with an aspect of the present disclosure;

FIG. 4 is a schematic side view of an embodiment of a simple cycle gas turbine system combining the cooling features of the systems of FIGS. 1 and 3, in accordance with an aspect of the present disclosure; and

FIG. 5 is a block diagram of the manner in which the absorption chiller utilizes the exhaust gas take-off stream of FIGS. 1-4 to generate a chilled fluid for use in a heat exchanger, in accordance with an aspect of the present disclosure.

### DETAILED DESCRIPTION OF THE INVENTION

One or more specific embodiments of the present invention will be described below. In an effort to provide a concise description of these embodiments, all features of an actual implementation may not be described in the specification. It should be appreciated that in the development of any such actual implementation, as in any engineering or design project, numerous implementation-specific decisions must be made to achieve the developers' specific goals, such as compliance with system-related and business-related constraints, which may vary from one implementation to another. Moreover, it should be appreciated that such a development effort might be complex and time consuming, but would nevertheless be a routine undertaking of design, fabrication, and manufacture for those of ordinary skill having the benefit of this disclosure.

When introducing elements of various embodiments of the present invention, the articles “a,” “an,” “the,” and “said” are intended to mean that there are one or more of the elements. The terms “comprising,” “including,” and “having” are intended to be inclusive and mean that there may be additional elements other than the listed elements.

As set forth above, gas turbine engines may produce a number of products of combustion. These products may include nitrogen oxides (NOₓ), sulfur oxides (SOₓ), carbon oxides (COₓ), and unburned hydrocarbons. Generally, reducing the relative concentration of these products within an exhaust gas may include reacting such products with other reactants in the presence of a catalyst. The reaction between NOₓ and a reductant such as ammonia (NH₃), for example, may occur within an exhaust duct assembly in the presence of a selective catalytic reduction (SCR) system. The catalyst lowers the activation energy of a reaction between the NOₓ and ammonia to produce nitrogen gas (N₂) and water (H₂O), thereby reducing the amount of NOₓ in the exhaust gas before the exhaust gas is released from the gas turbine system. Such catalyst systems may be referred to as “DeNOₓ” systems.

SCR systems may be used in a variety of different gas turbine systems, which range from relatively small-scale systems (e.g., aero-derivative systems) to larger, heavy-duty gas turbine systems. Small-scale systems produce exhaust gases having a relatively low temperature, while heavy-duty gas turbine systems produce exhaust gases with much higher temperatures. While exhaust gases from small scale systems (e.g., aero-derivative systems) have a temperature range that is generally amenable to the SCR process, the temperature of exhaust gases produced by heavy-duty systems is often much higher than acceptable operating ranges for the SCR process (e.g., temperatures suitable to maintain stability of the SCR catalyst). For example, in accordance with an embodiment of the present disclosure, the isotherm temperature of exhaust gases produced by a heavy-duty gas turbine engine may be greater than about 1000° F. (e.g., about 540° C.), such as between about 1100° F. and about 1300° F. (e.g., about 590° C. and about 705° C.), while an acceptable operating range of a “hot” SCR system (an SCR system having a relatively higher operating temperature range compared to other SCR systems) may be between about 800° F. and about 900° F. (e.g., about 425° C. and about 485° C.).

To reduce a temperature of these hot exhaust gases to the acceptable operating range for the SCR system, the exhaust gases may be mixed with tempering air to transfer heat from the exhaust gas to the tempering air and thereby cool the exhaust gas. Generally, the amount of tempering air therefore largely determines the amount of heat removed from the exhaust gas.

It is now recognized that the amount of tempering air used to reduce exhaust gas temperature generated in heavy-duty systems is much larger than amounts used in other systems. For example, a flow rate of tempering air suitable to cool the exhaust gas in heavy-duty gas turbine systems to an appropriate temperature for the SCR system may represent between about 20% and about 50%, such as about 30%, of the exhaust flow rate. This type of cooling can represent a significant energy input to cool the exhaust gas, which reduces plant efficiency. Additionally, introducing a flow of tempering air into the exhaust gas means that the resulting mixture should be homogenized using, for example, features that encourage turbulent flow. Accordingly, it is also now recognized that it may be desirable to reduce or altogether eliminate the need for tempering air in heavy-duty gas turbine systems (e.g., simple-cycle systems). Furthermore, it is also recognized that the heat from the exhaust gas generated by a gas turbine engine in such a system may be used to drive certain cooling features of the system, such as an absorption chiller.

In accordance with aspects of the present disclosure, the absorption chiller may utilize the exhaust gas heat to drive a cooling process that includes heat exchange between the exhaust gas and a medium in the absorption chiller. The exhaust gas used for this heat exchange may be a portion of the total exhaust gas generated by the gas turbine engine, and may be extracted from an exhaust duct assembly or similar feature of the system. This heat exchange causes the exhaust gas (the portion that is extracted) to be cooled. The cooled exhaust gas may be re-introduced to the exhaust path to facilitate cooling of the overall exhaust gas flow in the exhaust path.

Additionally, in certain embodiments of the present disclosure, the cooling process driven by this heat exchange may be used to generate a cooled or chilled heat exchange medium. The cooled heat exchange medium may be used, for example, to cool tempering air used in a tempering air system, and/or to provide additional cooling of the exhaust gas present within the exhaust path of the system.

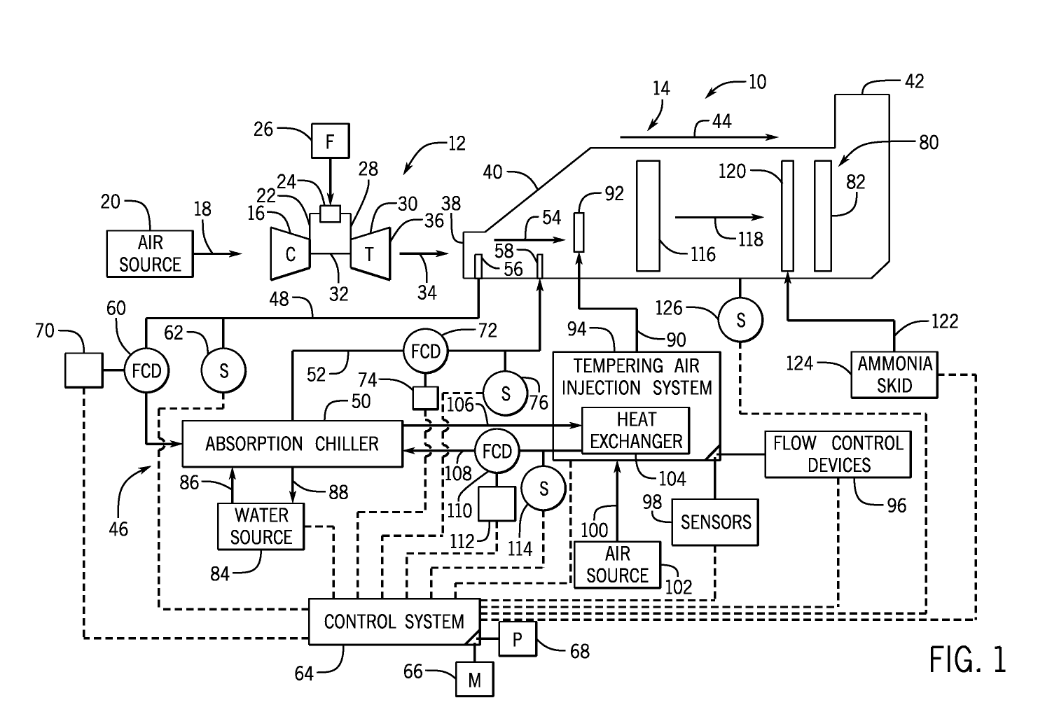

While the present disclosure may be applicable to a number of different gas turbine systems, the embodiments described herein may be particularly useful in simple cycle heavy-duty gas turbine systems that produce relatively high temperature exhaust gases (e.g., greater than 1000° F., about 540° C.). One example of a system having a configuration in accordance with certain aspects of the present disclosure is depicted in FIG. 1, which is a side elevational view of an embodiment of a simple cycle heavy-duty gas turbine system 10. More particularly, the simple cycle gas turbine system 10 of FIG. 1 includes a gas turbine engine 12 fluidly coupled to an exhaust processing system 14 utilizing the exhaust extraction and absorption chiller features of the present disclosure.

As illustrated, the gas turbine engine 12 includes a compressor 16 having intake features configured to intake air 18 from an air source 20. By way of non-limiting example, the air source 20 may include various components configured to intake and pre-treat (e.g., filter and silence) air taken in from the ambient environment. During operation, the compressor 16 intakes the air 18, and compresses the air to produce a compressed air feed 22 provided to a combustor section 24 of the gas turbine engine 12. In the combustor section 24, which includes one or more turbine combustors, the compressed air feed 22 is used for combustion of a fuel 26 (from a fuel source such as a pipeline or fluid storage vessel) to produce hot combustion gases 28. The hot combustion gases 28 generally include products of combustion such as carbon oxides as well as sulfur and nitrogen oxide species. In certain embodiments, combustion parameters such as fuel-to-air ratio, fuel and air volume, and so forth, may control temperatures in the combustor section 24 and the relative amounts of the gas species generated by combustion.

To extract work from the hot combustion gases 28, the gas turbine engine 12 includes a turbine 30, which includes a plurality of turbine stages having turbine blades attached to rotating wheels. The wheels are attached to a shaft 32 mechanically coupling the turbine 30 to the compressor 16, and in certain embodiments to an additional load such as an electrical generator. The turbine 30 is configured to receive the hot combustion gases 28 and includes a shroud that flows the hot combustion gases 28 over the turbine blades. The turbine blades and associated turbine wheels are driven into rotation by the hot combustion gases, which in turn cause the shaft 32 to rotate. Compression stages in the compressor 16, which are mechanically coupled to the shaft 32, are driven by this rotation.

The turbine 30 is configured to discharge the combustion gases from which work has been extracted as an exhaust gas 34. More specifically, an outlet 36 of the turbine 30 is fluidly coupled to an inlet 38 of the exhaust processing system 14 (e.g., the inlet of an exhaust duct assembly 40). The exhaust duct assembly 40 may include a single duct, or a combination of ducts that are coupled to one another fluidly and physically. As a more specific example, the exhaust duct assembly 40 may include several sections, such as a transition section and an exhaust duct section. During operation, the exhaust processing system 14 receives and processes the exhaust gas 34 (e.g., for cooling, to reduce certain combustion products) before the exhaust gas 34 is directed out of the system 10 (e.g., via stack 42).

In accordance with present embodiments, the exhaust processing system 14 may also include features located externally relative to the exhaust duct assembly 40, the features being configured to facilitate cooling of the stream of exhaust gas 34 as it passes through the exhaust duct assembly 40 in a downstream direction 44. More specifically, the exhaust processing system 14 may include an absorption cooling system 46 configured to receive a take-off stream 48 of the exhaust gas 34 and to cool the take-off stream 48 using an absorption chiller 50 to produce a cooled take-off stream 52. The cooled take-off stream 52 may be re-introduced into an exhaust flow path 54 of the exhaust gas 34 through the exhaust duct assembly 40.

To allow for removal and re-introduction of the exhaust gas 34, the exhaust duct assembly 40 may include an absorption cooling inlet 56 and an absorption cooling outlet 58, which may each include one or more openings in a wall of the exhaust duct assembly 40. In the illustrated embodiment, the absorption cooling inlet 56 includes a tap-in located upstream of a tap-in of the absorption cooling outlet 58.

The absorption cooling inlet 56 leads to (is fluidly coupled to) a conduit configured to flow the take-off stream 48 to the absorption chiller 50. The conduit may represent all or a portion of a take-off flow path. One or more take-off flow control devices 60 (e.g., valves, pumps, fans, blowers) and one or more take-off sensors 62 (e.g., thermocouples, thermistors, pressure transducers, flow meters) may be positioned along the take-off flow path extending between the absorption cooling inlet 56 and the absorption chiller 50 for controlling the amount and/or flow characteristics of the take-off stream 48. For example, a control system 64 of the gas turbine system 10 may include instructions stored on a local memory 66 and executable by a processor 68 to control a flow of the take-off stream 48. The control system 64 may be communicatively coupled to an actuator 70 of the one or more take-off flow control devices 60 and to the one or more take-off sensors 62. Such communication allows the control system 64 to send control signals as appropriate to the actuator 70 to adjust operation of the one or more take-off flow control devices 60 based at least in part on feedback signals provided by the one or more take-off sensors 62.

Generally, the control system 64 is configured to monitor parameters of the exhaust gas 34, such as composition (e.g., levels of COₓ, SOₓ, NOₓ, and so forth), temperature, pressure, and so on. The control system 64 may also monitor aspects relating to the ambient environment (e.g., the temperature of ambient air, the humidity of the ambient air), and/or aspects relating to the gas turbine engine 12, such as the loading of the gas turbine engine 12. The loading of the gas turbine engine 12 may affect the composition and temperature of the exhaust gas 34, as higher loading of the engine 12 may be associated with higher combustion temperatures. The control system 64 may control various parameters of the exhaust processing system 14 based on these monitored parameters. For example, the control system 64 may control cooling of the exhaust gas 34 based on any one or a combination of the parameters listed above. More specific control aspects are described in further detail below.

In certain embodiments, the take-off stream 48 may be directed to and through the absorption chiller 50 using the take-off flow control devices 60, which may not provide sufficient motive force for returning the cooled take-off stream 52 to the exhaust duct assembly 40. Additional or alternative control of the cooled take-off stream 52 may be enabled by one or more return flow control devices 72 and their associated actuators 74, which may be communicatively coupled to the control system 64. Exhaust gas return sensors 76 (e.g., thermocouples, thermistors, pressure transducers, flow meters) may be positioned along the exhaust gas return path (e.g., a cooled take-off stream flow path) extending between the absorption chiller 50 and the absorption cooling outlet 58 of the exhaust duct assembly 40, and may be communicatively coupled to the control system 64 to enable the control system 64 to monitor aspects of the cooled take-off stream 52.

In this example arrangement, the control system 64 may flow the take-off stream 48 through the absorption chiller 50 using only the take-off flow control devices 60, only the return flow control devices 72, or a combination of these. The manner in which these flows are controlled may depend on, for example, the level of cooling for the exhaust gas 34 that is required for suitable treatment at a selective catalytic reduction (SCR) system 80 of the exhaust processing system 14 (more particularly, a catalyst 82 of the SCR system 80). Indeed, the control system 64 may control a number of different flows based on such cooling requirements.

As one example, in the illustrated embodiment, the control system 64 is communicatively coupled to a water source 84, which supplies one or more flows of cooling water 86 to the absorption chiller 50 and receives one or more flows of return water 88. The water source 84 may represent a single source of water (e.g., a single tank or other source of water such as boiler feed water, or water from a cooling tower), or may represent a plurality of sources of water (e.g., a plurality of tanks or similar sources of water). As described in further detail below, the one or more flows of cooling water 86 may function to condense refrigerant water present within the absorption chiller 50, and may remove heat of dissolution generated from an absorption process occurring within the absorption chiller 50. The flows of cooling water 86 may be controlled, for example, based on the rate at which the refrigerant water needs to be condensed and the amount of thermal energy generated during the absorption process.

In accordance with present embodiments, the control system 64 may also control a flow of tempering air 90 into a tempering air injection grid 92 positioned within the exhaust duct assembly 40 to control cooling of the exhaust gas 34. The tempering air 90 is provided by a tempering air injection system 94, which may include one or more tempering air flow control devices 96 and one or more sensors 98 (e.g., thermocouples, thermistors, pressure transducers, flow meters) configured to allow control of the intake and distribution of air 100 from an air source 102. Specifically, the control system 64 may control the flow of the air 100 into the tempering air injection system 94, and through one or more flow paths configured to allow treatment and/or cooling of the air 100 before injection into the exhaust duct assembly 40.

In the illustrated embodiment, the tempering air injection system 94 includes a heat exchanger 104 configured to receive a flow of chilled water 106 (or other chilled medium) from the absorption chiller 50. The flow of chilled water 106 may be generated via evaporative cooling within the absorption chiller 50. In certain embodiments, the flow of chilled water 106 may include additives that facilitate heat exchange and depress the freezing point of the water. By way of non-limiting example, the flow of chilled water 106 may include salt and/or glycol additives such as ethylene glycol. The heat exchanger 104 is configured to enable the air 100 to be cooled via heat exchange with the flow of chilled water 106, thereby generating the tempering air 90 and a return water flow 108 that is directed back to the absorption chiller 50. The control system 64 may control the flows 106, 108 using one or more chilled water flow control devices 110 (and their associated actuators 112) and one or more chilled water sensors 114 (e.g., thermocouples, thermistors, pressure transducers, flow meters) positioned along a flow path of either or both of the flows 106, 108.

The amount of tempering air 90 injected into the exhaust flow path 54 may depend on the amount of cooling provided by the absorption chiller 50, as well as the cooling requirements of the SCR system 80 and the temperature of the exhaust gas 34. In certain embodiments, the control system 64 may monitor loading of the heavy-duty gas turbine engine 12, and may adjust an amount of the tempering air 90 used to cool the exhaust gas 34 in response to detecting a change in the loading of the heavy-duty gas turbine engine 12. In still further embodiments, the control system 64 may be configured to monitor a parameter of the exhaust gas 34 within the exhaust duct assembly 40, and may adjust an amount of the tempering air 90 used to cool the exhaust gas 34 in response to detecting a change in the monitored parameter of the exhaust gas 34.

Upon injection, the tempering air 90 mixes and undergoes heat exchange with the exhaust gas 34, which may be facilitated by features positioned within the exhaust duct assembly 40 (e.g., one or more turbulators 116). A resulting cooled exhaust gas flow 118 is directed through an ammonia injection grid 120, which is configured to inject ammonia 122 provided from an ammonia skid 124. At least a portion of the ammonia skid 124 (e.g., flow control devices) may be controlled by the control system 64. The ammonia 122, when mixed with the cooled exhaust stream 118 in the presence of the SCR catalyst 82, acts as a reducing agent that reduces the NOₓ species in the exhaust gas into nitrogen gas and water. The amount of the ammonia 122 (and/or other reducing agent) provided via the grid 120 may largely depend on the amount of cooled exhaust gas 118 to be treated by the SCR catalyst 82, as well as levels of NOₓ present within the exhaust gas. This information may be provided by one or more exhaust gas sensors 126 (e.g., lambda sensors, CO sensors, NOₓ sensors, temperature sensors) positioned at various positions along the exhaust duct assembly 40. Indeed, the one or more exhaust gas sensors 126 may be used to provide both feed forward and feed back information to the control system 64 for the control of the various flows intended to cool and treat the exhaust gas 34.

Again, as set forth above, it is now recognized that the exhaust gas 34 may be utilized as the heating fluid that drives the generator portion of an absorption chiller. In accordance with the present disclosure, the take-off location of the take-off stream 48 and the re-introduction location of the cooled take-off stream 52 may vary across different embodiments. Generally, in FIG. 1, the take-off stream 48 is taken off at the absorption cooling inlet 56 at a location between the inlet 38 of the duct 40 and the tempering air injection grid 92 (i.e., upstream of the tempering air injection grid 92). Additionally, the cooled take-off stream 52 is injected via the absorption cooling outlet 58 upstream of the tempering air injection grid 92. Such a configuration may be desirable to facilitate mixing and cooling of the tempering air 90, the cooled take-off stream 52, and the bulk exhaust gas 34 using the turbulators 116, and to utilize exhaust gas 34 having a higher temperature relative to exhaust gas that has been cooled using the tempering air 90 and/or cooled by heat transfer to various physical features of the exhaust processing system 14. However, in other embodiments, it may be desirable for the take-off stream 48 to be taken off downstream of the tempering air injection grid 92, such as downstream of the turbulators 116.

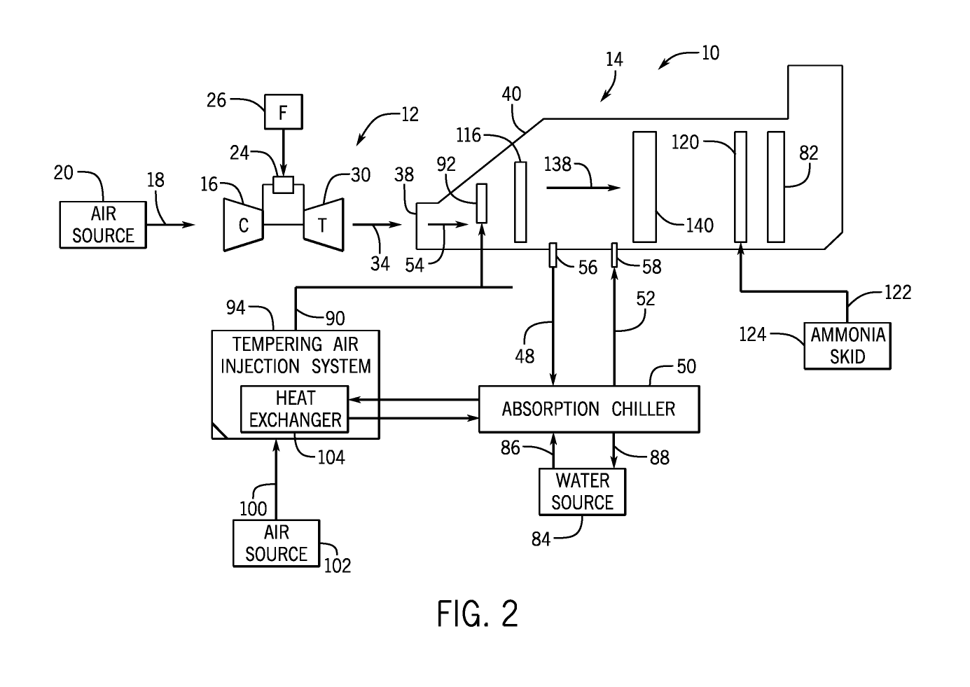

FIG. 2 depicts an example of such an embodiment. Certain features of the system 10 of FIG. 1 are not reproduced in FIG. 2 for clarity, but it should be noted that those components, such as the various flow control devices, sensors, and the control system 64, are also present. The embodiment of the system 10 in FIG. 2 has the absorption cooling inlet 56 and the absorption cooling outlet 58 positioned downstream of the tempering air injection grid 92. Accordingly, in this embodiment, the take-off stream 48 may include a mixture of the tempering air 90 and the exhaust gas 34. The turbulators 116 may be positioned upstream of the absorption cooling inlet 56 so that the take-off stream 52 has a substantially homogenous distribution of the tempering air 90 and the exhaust gas 34 (e.g., due to the introduction of turbulent flow). The mixture of the tempering air 90 and the exhaust gas 34 may be considered a tempered exhaust gas flow 138, and the take-off stream 48 may essentially include this mixture.

The system 10 may also include an additional set of turbulators 140 positioned downstream of the absorption cooling outlet 58 and upstream of the ammonia injection grid 120. The configuration of FIG. 2 may therefore introduce the cooled take-off stream 52 back into the exhaust gas path 54 at a position where the cooled take-off stream 52 may be mixed with the tempered exhaust gas flow 138 and subsequently passed through the additional turbulators 140. The additional turbulators 140 may encourage turbulent flow in the mixture of the cooled take-off stream 52 and the tempered exhaust gas flow 138, which facilitates mixing and heat exchange.

As shown, the additional turbulators 140 may be positioned upstream of the ammonia injection grid 120. However, in other embodiments, the additional turbulators 140 may be positioned downstream of the ammonia injection grid 120 but upstream of the SCR catalyst 82 to encourage mixing of and heat exchange between the cooled take-off stream 52, the tempered exhaust gas flow 138, and the ammonia 122 before arriving at the SCR catalyst 82.

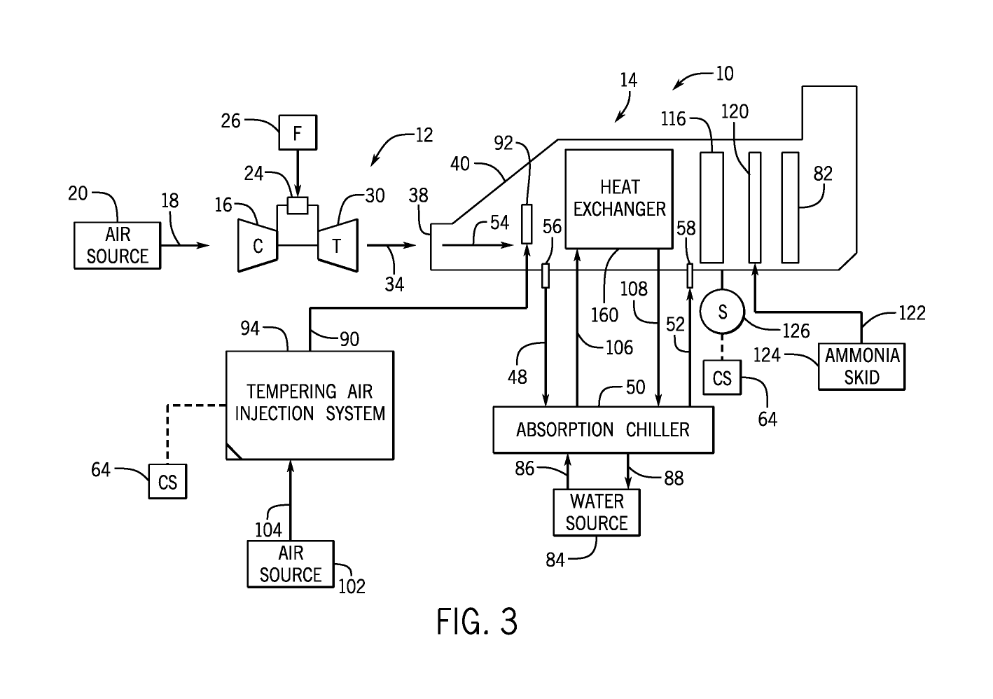

As in the system 10 of FIG. 1, the system 10 of FIG. 2 utilizes the heat exchanger 104 to cool intake air 100 and generate the tempering air 90 using the flow of chilled water 106. However, in certain embodiments and as shown in FIG. 3, the system 10 direct the flow of chilled water 106 to an exhaust gas heat exchanger 160 positioned within the exhaust gas path 54 to cool the exhaust gas 34 (or the tempered exhaust gas 138). In this embodiment, the control system 64 may utilize a reduced amount of the tempering air 90 to cool the exhaust gas 34 and, indeed, in certain situations may altogether eliminate the use of the tempering air 90. For example, the control system 64 may control cooling of the exhaust gas 34 primarily by controlling heat exchange via the exhaust gas heat exchanger 160, and while maintaining the tempering air injection system 94 in an off, standby, or reduced throughput operating state. While the exhaust gas heat exchanger 160 is depicted as being positioned downstream of the tempering air injection grid 92 along the exhaust flow path 54, the present disclosure is not limited to this configuration. For example, in certain embodiments, the respective positions of the tempering air injection grid 92 and the exhaust gas heat exchanger 160 may be reversed such that the exhaust gas heat exchanger 160 is positioned upstream of the tempering air injection grid 92.

It is now recognized that reducing the amount of tempering air 90 utilized for cooling the exhaust gas 34 may be desirable to facilitate maintenance of the exhaust gas 34 in a homogenous state (e.g., to reduce or eliminate pockets of tempering air or other gaseous species). In addition, it is now recognized that the use of the exhaust gas 34 to drive the absorption cooling process within the absorption chiller 50 both cools the exhaust gas 34 and reduces reliance on outside power sources for cooling. For example, it is now recognized that the coefficient of performance (COP) for cooling the exhaust gas 34 (the amount of cooling of the exhaust gas that is achieved relative to the amount of work input to the system) may be increased by reducing reliance on tempering air 90 to cool the exhaust gas 34, and instead cooling the exhaust gas 34 utilizing the exhaust gas heat exchanger 160 and the absorption chiller 50. That is, cooling using the exhaust gas heat exchanger 160 and the absorption chiller 50 may be more efficient than cooling using the tempering air injection system 94 (using the tempering air injection system 94 without absorption chiller integration).

Thus, in accordance with present embodiments, the system 10 of the present disclosure may utilize reduced amounts of tempering air 90 relative to typical systems. As one example, in certain heavy duty simple cycle gas turbine systems (not aero-derivative systems) producing exhaust isotherm temperatures of 1240° F. (about 670° C.), to reach the 800-900° F. (about 430-480° C.) temperature for the SCR catalyst 82, the tempering air 90 may represent a flow volume that is equal to about 30% of the exhaust flow volume. This corresponds to about 2% temperature reduction of the exhaust gas 34 for every 1% of equal flow volume of tempering air. It may be possible to reduce or altogether eliminate the need for tempering air using the exhaust gas heat exchanger 160 and absorption chiller 50 configuration of the present disclosure. For example, in an embodiment of a simple cycle heavy duty gas turbine system of the present disclosure, the temperature of the exhaust gas 34 may be reduced by between 2.5% and 5% for every 1% of equal tempering air flow volume. In certain embodiments, this may correspond to a temperature drop from an isotherm temperature of the exhaust gas 34 of about 1240° F. to a range of about 800° F. to about 900° F. using a flow volume of tempering air that is equal to no more than 20%, no more than 10%, or no more than 5% of the exhaust gas flow volume.

More generally, the exhaust processing system 14 of the simple cycle heavy-duty gas turbine system 10 may be configured to receive the exhaust gas 34 at an initial isotherm temperature that is higher than an acceptable temperature for treatment at the SCR catalyst 82. The cooling features of the exhaust processing system 14 of the present disclosure are configured to cool the exhaust gas 34 to a temperature that is within an appropriate range for treatment at the SCR catalyst 82. This cooling may be achieved using tempering air that is equal to between 1% and 20% of the exhaust flow volume.

To achieve this level of cooling using reduced tempering air flows, the exhaust gas heat exchanger 160 may include one or more structures having an appropriate thickness, material construction, and surface area that enables heat exchange between the exhaust gas 34 and the flow of chilled water 106. For example, the exhaust gas heat exchanger 160 may include heat exchange coils positioned directly in the exhaust gas path 54, a plurality of shell- and tube heat exchangers configured to pass the exhaust gas 34 through a series of tubes (e.g., a grid of parallel tubes), or any other appropriate configuration. The flow of chilled water 106 may be provided in a sufficient amount (e.g., at a sufficient flow rate) and at a sufficient temperature to cool the exhaust gas 34 by a predetermined amount.

Generally, the control system 64 may control cooling of the exhaust gas 34 via the exhaust gas heat exchanger 160 by controlling parameters of the flow of chilled water 106 through the exhaust gas heat exchanger 160. Such control may be performed using the flow control device 110 (see FIG. 1). For instance, the control system 64 may adjust the circulation rate of the flow of chilled water 106 through the exhaust gas heat exchanger 160. Controlling the mass flow of the chilled water through the heat exchanger 160 and the absorption chiller 50 also affects the residence time of the water within the heat exchanger 160 and the absorption chiller 50, and allows for monitoring and control of the temperature difference between the flow of chilled water 106 and the return water 108. Accordingly, in certain embodiments, the system 10 may include sensors 114 disposed along the respective flow paths of both of the chilled water 106 and the return water 108. The temperature difference between the chilled water 106 and the return water 108 may be indicative of heat exchange efficiency and the flow and temperature parameters of the exhaust gas 34.

In certain embodiments, the circulation rate may also be adjusted based at least in part on various feed forward and/or feedback information obtained from sensors 98 (see FIG. 1) within the tempering air injection system 94, sensors 62 and 76 (see FIG. 1) positioned along the flow paths of the take-off stream 48 and the cooled take-off stream 52, respectively, one or more of the exhaust gas sensors 126, or any combination thereof. For example, the control system 64 may adjust the circulation rate of the flow of chilled water 106 based on a feed forward input including a temperature of the exhaust gas 34 obtained upstream of the heat exchanger 160 (e.g., between the inlet 38 of the exhaust duct assembly 40 and the tempering air injection grid 92). Additionally or alternatively, the control system 64 may adjust the circulation rate of the flow of chilled water 106 based on a feedback input including a temperature of the exhaust gas 34 obtained downstream of the exhaust gas heat exchanger 160 (e.g., between the exhaust gas heat exchanger 160 and the SCR catalyst 82).

As set forth above, it is now recognized that the thermal energy contained in the take-off stream 48 may be used to drive the absorption cooling process within the absorption cooler 50 (specifically, the generator section). Accordingly, the flow of chilled water 106 may also be controlled based on the temperature of the take-off stream 48, which in turn corresponds to the rate at which certain processes occur within the absorption chiller 50. These processes affect the rate at which the chilled water 106 may be generated, or the rate at which the return water 108 may be chilled to produce the flow of chilled water 106.

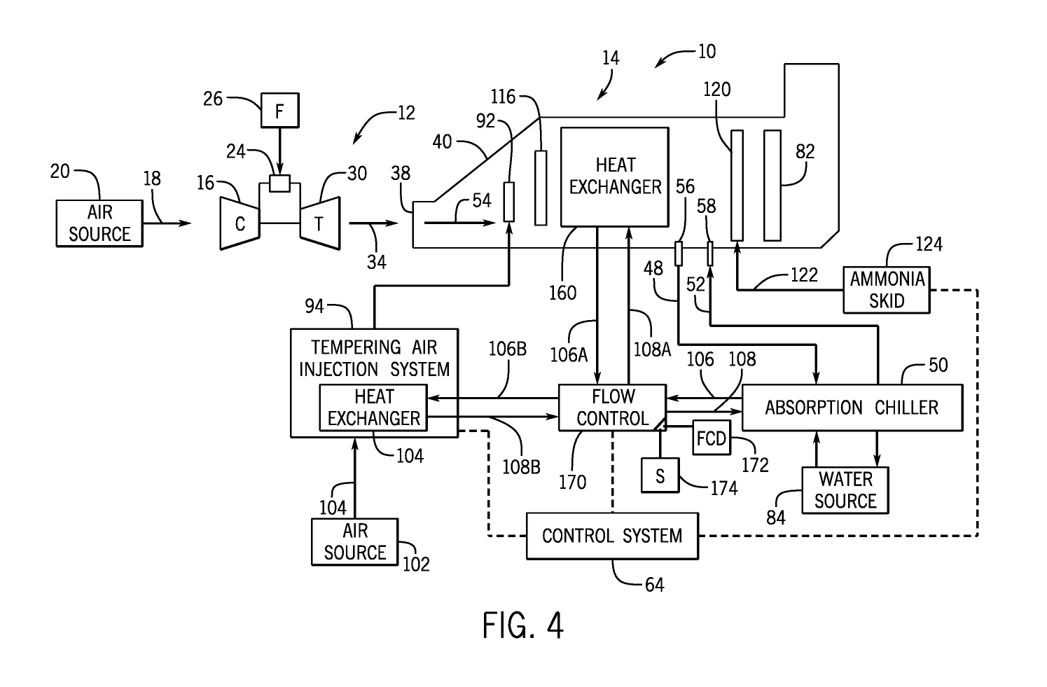

It should be noted that these control parameters are not limited to the configuration of the system 10 of FIG. 3. Rather, the flow of the chilled water 106 to the heat exchanger 104 in the tempering air injection system 94, as in the system 10 of FIGS. 1 and 2, may be controlled based on these and/or similar parameters. Indeed, as shown in FIG. 4, certain embodiments of the system 10 may include both the heat exchanger 104 in the tempering air injection system 94 and the exhaust gas heat exchanger 160, and both may be configured to receive a flow of the chilled water 106. As noted above with respect to FIG. 3, while the exhaust gas heat exchanger 160 is depicted in FIG. 4 as being positioned downstream of the tempering air injection grid 92 along the exhaust flow path 54, the present disclosure is not limited to this configuration. In certain embodiments, the respective positions of the tempering air injection grid 92 and the exhaust gas heat exchanger 160 may be reversed such that the exhaust gas heat exchanger 160 is positioned upstream of the tempering air injection grid 92.

In such embodiments, a flow control system 170 having one or more flow control devices 172 (e.g., valves, pumps, blowers, fans), one or more sensors 174 (e.g., thermocouples, flow meters, pressure transducers), and/or one or more flow distribution devices (e.g., a flow distribution header) may function to split the flow of the chilled water 106 between the heat exchangers 104, 160 as appropriate. The flow control system 170, and in particular the flow control devices 172 and the sensors 174, are in communication with the control system 64. The flow control system 170 is intended to represent a collection of flow control devices, flow distribution devices, actuators, sensors, and so forth, appropriately positioned along one or more flow paths to collectively carry the flow of chilled water 106 and the return water 108 to and from the absorption chiller 50.

The control system 64 may control a split between a first flow of the chilled water 106A from the absorption chiller 50 to the exhaust gas heat exchanger 160 and a second flow of the chilled water 106B from the absorption chiller 50 to the heat exchanger 104 in the tempering air injection system 94. Specifically, the flow of chilled water 106 may first flow from the absorption chiller 50 to one or more features of the flow control system 170, such as a flow distribution header. The flow control system 170 may then, via control by the control system 64, cause the flow to be split into a first amount of the chilled water 106 sent to the exhaust gas heat exchanger 160 (as first chilled water 106A) and a second amount of the chilled water 106 sent to the heat exchanger 104 (as second chilled water 106B). The split may be controlled such that the ratio of flow volume or mass flow of the first flow of chilled water 106A to second flow of chilled water 106B may be controlled in the range of 100:0 to 0:100. For example, the ratio may be between 100:0 and 50:50 first flow of chilled water 106A to second flow of chilled water 106B, or vice-versa, depending on cooling requirements and the particular configuration of the system 10. In one embodiment, none of the chilled water 106 is sent to the heat exchanger 104 of the tempering air injection system 94. In this embodiment, no tempering air 90 may be provided for cooling the exhaust gas 34. That is, the exhaust gas 34 may be cooled using only heat exchange features other than the tempering air injection system 94.

A number of factors may control the split of the chilled water 106. As one example, the amount of chilled water 106 flowed to the exhaust gas heat exchanger 160 relative to the chilled water 106 flowed to the tempering air injection system 94 may be based on the measured effect of cooling the exhaust gas 34 using only the exhaust gas heat exchanger 160 versus using a combination of the exhaust gas heat exchanger 160 and the tempering air 90. As noted above, the amount of tempering air 90 utilized for cooling may depend on various parameters of the system 10, such as gas turbine loading, exhaust gas throughput, exhaust gas temperature, exhaust gas pressure, exhaust gas composition, and so forth. Accordingly, the control system 64 may control the split of the chilled water 106 based on loading of the heavy-duty gas turbine engine 12, based on ambient air conditions, based on a sensed temperature of exhaust gas 34 within the exhaust duct assembly, or any combination thereof.

Indeed, in accordance with present embodiments, utilizing less tempering air 90 may be desirable to enhance homogeneity of the exhaust gas 34. In other words, using less tempering air may be desirable to help ensure more homogenous exhaust gas 34 (e.g., a more even distribution of the exhaust gas constituents, taken along a cross-section of the exhaust gas flow 54). Reducing reliance on tempering air cooling may also enhance the efficiency of the system 10.

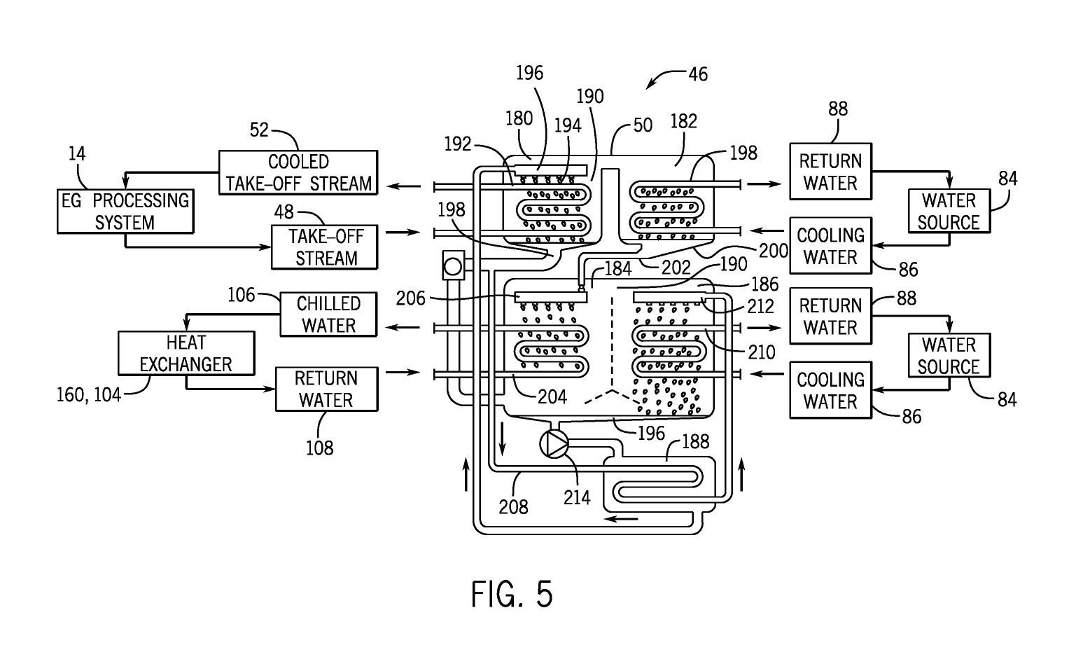

Again, in accordance with embodiments of the present disclosure, a stream of take-off exhaust gas may be used to drive an absorption chiller to simultaneously cool the take-off stream and generate a chilled stream that is capable of being used for further heat exchange. An example of the manner in which the exhaust processing system 14 may be integrated with the absorption chiller 50 is depicted in FIG. 5, which is a schematic view of an embodiment of the absorption cooling system 46.

Generally, the absorption chiller 50 utilized in embodiments of the present disclosure will include various regions where some form of heat exchange occurs. In the embodiment of FIG. 5, the absorption chiller 50 is a single effect absorption chiller that utilizes a single generator section. However, in other embodiments, the absorption chiller 50 may be a double effect absorption chiller having two generator sections.

More specifically, the illustrated absorption chiller 50 includes a generator section 180, a condenser section 182 fluidly coupled to the generator section 180, an evaporator section 184 fluidly coupled to the condenser section 182, and an absorption section 186 fluidly coupled to the evaporator section 184. A chiller heat exchange section 188 is fluidly coupled to the generator section 180 and to the absorption section 186. The chiller heat exchange section 188 facilitates heat exchange between the output streams of both sections to generate input streams for the other respective section.

In the embodiment of FIG. 5, the absorption chiller 50 utilizes water as a refrigerant, and the water refrigerant undergoes a refrigeration cycle within the absorption chiller 50 to cool at least one fluid stream. Refrigerant vapor 190 generally permeates every section of the absorption chiller 50. Starting with the generator section 180, as shown, the generator section 180 includes a generator heat exchanger 192 configured to receive the take-off stream 48 and place the take-off stream 48 in a heat exchange relationship with a dilute absorber solution 194. In the illustrated embodiment, the generator heat exchanger 192 includes a plurality of heat exchange coils, and the dilute absorber solution 194 is dispersed over the generator heat exchanger 192 using a dilute absorber solution injector 196. However, in other embodiments, other configurations for heat exchange between the dilute absorber solution 194 and the generator heat exchanger 192 may be utilized. In accordance with present embodiments, the dilute absorber solution 194 is a dilute aqueous (water-based) solution of a hygroscopic material (e.g., lithium bromide).

This dispersal results in thermal energy transfer from the take-off stream 48 to the dilute absorber solution 194, which causes water within the dilute absorber solution 194 to evaporate and causes the cooled take-off stream 52 to be generated. Again, the cooled take-off stream 52 may, itself, be utilized to directly cool the exhaust gas 34 within the exhaust processing system 14 (e.g., by re-introduction into the exhaust gas 34 still within the exhaust path 54). The water evaporation within the generator section 180 generates a concentrated absorber solution 198 and the refrigerant vapor 190. The process involving the concentrated absorber solution 198 is described in further detail below. The refrigerant vapor 190, which is water in its vapor state within the generator section 180, moves to an area of lower pressure within the condenser section 182.

The condenser section 182 includes a condenser heat exchanger 198, which is configured to receive the cooling water 86 from the water source 84 and place the cooling water 86 in a heat exchange relationship with the refrigerant vapor 190. At the temperature and pressure within the condenser section 182, some of the refrigerant vapor 190 condenses to form refrigerant liquid 200. The pressure and temperature gradient between the generator section 180 and the condenser section 182 also facilitates evaporation of water from the dilute absorber solution 194 and movement of the refrigerant vapor 190 toward the condenser section 182.

The refrigerant liquid 200 flows through a fluid connection 202 coupling the condenser section 182 and the evaporator section 184. The condenser section 182, in its most general sense, includes features that facilitate evaporation of the refrigerant liquid 200 to cause evaporative cooling. In the illustrated embodiment, the evaporator section 184 includes an evaporator heat exchanger 204, which is configured to receive the return water 108 and place the return water 108 in a heat exchange relationship with the refrigerant liquid 200. The refrigerant liquid 200 may be dispersed over the evaporator heat exchanger 204 using, for example, a refrigerant liquid injector 206.

More specifically, as the refrigerant liquid 200 contacts a surface of the evaporator heat exchanger 204, the refrigerant liquid 200 may evaporate off this surface. Accordingly, not only does heat exchange occur between the refrigerant liquid 200 and the return water 108 within the evaporator heat exchanger 204, but the evaporation of the refrigerant liquid 200 also removes additional thermal energy (e.g., the heat of vaporization) from the return water 108. This evaporative cooling of the return water 108 generates the chilled water 106. Again, the chilled water 106 may be provided to the exhaust gas heat exchanger 160 to reduce or eliminate the use of tempering air to cool the exhaust gas 34. Additionally or alternatively, the chilled water 106 may be provided to the heat exchanger 104 in the tempering air injection system 94 to facilitate generation of the tempering air 90.

Returning now to the concentrated absorber solution 198 produced within the generator section 180, as shown, the solution 198 is passed via a fluid conduit 208 through the chiller heat exchange section 188 and to the absorber section 186. The absorber section 186 includes an absorber heat exchanger 210, which is configured to receive the cooling water 86 from the water source 84. The absorber heat exchanger 210 places the cooling water 86 in a heat exchange relationship with the refrigerant vapor 190, as well as with the concentrated absorber solution 198, which is dispersed using a concentrated absorber solution injector 212. The strong affinity of the hygroscopic material in the concentrated absorber solution 198 for water, in combination with the cooled surface of the absorber heat exchanger 210, encourages the refrigerant vapor 190 to be drawn into the concentrated absorber solution 198. This causes the dilute absorber solution 196 to be formed, and also creates a vacuum effect between the evaporator section 184 and the absorber section 186 to facilitate the refrigeration cycle.

To further facilitate the refrigeration cycle and motivation of the absorber solutions through the absorption chiller 50, a solution pump 214 may be positioned at a fluid outlet 216 (a dilute absorber solution outlet) of the absorber section 186. As the solution pump 214 draws the dilute absorber solution 196 out of the absorber section 186, the solution pump 214 further encourages continuation of the refrigeration cycle of the refrigerant water by, for instance, maintaining the level of refrigerant liquid 202 within the absorber section 186 at a relatively low level. The solution pump 214 is configured to pump the dilute absorber solution 196 through the chiller heat exchange section 188, where it undergoes heat exchange with the concentrated absorber solution 198. The solution pump 214, as illustrated, motivates the dilute absorber solution 196 toward the generator section 180, and the absorption cooling cycle continues as described.

In other embodiments, the absorption chiller 50 may have specific configurations in regard to the exact manner in which the refrigerant vapor 190 and the refrigerant liquid 202 are generated and passed through the absorption chiller 50 that are different than those presented herein. However, present embodiments encompass any appropriate configuration in which the take-off stream 48 of exhaust gas is utilized to impart sufficient thermal energy to generate the refrigerant liquid 190 from the dilute absorber solution 196. In addition, present embodiments encompass any appropriate configuration where, in combination with utilizing the take-off stream 48 as set forth above, the chilled water 106 (or other chilled fluid) is utilized for heat exchange with exhaust gas within the exhaust processing system 14 and/or is utilized for heat exchange with air for use as tempering air within the exhaust processing system 14.

Technical effects of the invention include the use of thermal energy contained within exhaust gas generated by a gas turbine engine to drive an absorption cooling process that is in turn used to cool the exhaust gas. Using the exhaust gas in this manner may increase the efficiency of simple cycle heavy-duty gas turbine engines by reducing or eliminating their reliance on tempering air for exhaust cooling. For example, the coefficient of performance (COP) for cooling the exhaust gas (the amount of cooling of the exhaust gas that is achieved relative to the amount of work input to the system) may be increased by reducing reliance on tempering air to cool the exhaust gas, and instead cooling the exhaust gas utilizing an exhaust gas heat exchanger and an absorption chiller. Cooling using the exhaust gas heat exchanger and the absorption chiller may be more efficient than cooling using a tempering air injection system.

This written description uses examples to disclose the invention, including the best mode, and also to enable any person skilled in the art to practice the invention, including making and using any devices or systems and performing any incorporated methods. The patentable scope of the invention is defined by the claims, and may include other examples that occur to those skilled in the art. Such other examples are intended to be within the scope of the claims if they have structural elements that do not differ from the literal language of the claims, or if they include equivalent structural elements with insubstantial differences from the literal languages of the claims.

1. A gas turbine system, comprising:
a gas turbine engine configured to combust a fuel and produce an exhaust gas;
an exhaust duct assembly fluidly coupled to the gas turbine engine and configured to receive the exhaust gas from the gas turbine engine; and
an absorption chiller fluidly coupled to the exhaust duct assembly and configured to receive a take-off stream of exhaust gas from the exhaust duct assembly via an exhaust take-off path, wherein the absorption chiller is configured to use the take-off stream of exhaust gas to drive at least a portion of an absorption cooling process to generate a cooled take-off stream of exhaust gas; and
wherein the exhaust duct assembly is configured to receive the cooled take-off stream of exhaust gas from the absorption chiller via a cooled take-off path and to mix the cooled take-off stream of exhaust gas with exhaust gas present within the exhaust duct assembly to cool the exhaust gas.

2. The gas turbine system of claim 1, wherein the exhaust duct assembly comprises an absorption cooling inlet and an absorption cooling outlet, wherein the exhaust take-off path extends from the absorption cooling inlet to the absorption chiller, and wherein the cooled take-off path extends from the absorption chiller to the absorption cooling outlet.

3. The gas turbine system of claim 2, wherein the absorption chiller comprises a generator section having a generator heat exchanger, wherein the generator heat exchanger is configured to place the take-off stream of exhaust gas in heat exchange with a dilute absorber solution to produce the cooled take-off stream of exhaust gas and a concentrated absorber solution.

4. The gas turbine system of claim 1, comprising an exhaust gas heat exchanger positioned within the exhaust duct assembly along an exhaust flow path configured to flow the exhaust gas through the exhaust duct assembly, wherein the exhaust gas heat exchanger is configured to receive a chilled water stream from the absorption chiller and to place the chilled water stream in heat exchange with the exhaust gas to cool the exhaust gas.

5. The gas turbine system of claim 4, comprising a cooling circuit extending between the exhaust gas heat exchanger and an evaporator heat exchanger of an evaporator section of the absorption chiller, wherein the cooling circuit is arranged to flow water such that the chilled water stream is generated in the evaporator heat exchanger and a return water stream is generated in the exhaust gas heat exchanger.

6. The gas turbine system of claim 4, wherein the exhaust gas heat exchanger is positioned upstream of a selective catalytic reduction (SCR) catalyst configured to reduce NOₓ present within the exhaust gas.

7. The gas turbine system of claim 6, comprising an ammonia skid having a source of ammonia and one or more flow paths configured to direct ammonia to an ammonia injection grid positioned within the exhaust duct assembly upstream of the SCR catalyst.

8. The gas turbine system of claim 1, comprising a tempering air injection system configured to inject tempering air into an exhaust gas flow path of the exhaust duct assembly to cool the exhaust gas.

9. The gas turbine system of claim 8, wherein the tempering air injection system comprises a heat exchanger configured to receive a chilled water stream from the absorption chiller and to place the chilled water stream in heat exchange with air to cool the air and thereby generate the tempering air.

10. The gas turbine system of claim 8, wherein the tempering air injection system is configured to inject the tempering air via a tempering air injection grid positioned along the exhaust gas flow path.

11. The gas turbine system of claim 10, wherein the tempering air injection grid is positioned upstream of a selective catalytic reduction (SCR) catalyst configured to reduce NOₓ present within the exhaust gas.

12. The gas turbine system of claim 8, comprising a control system communicatively coupled to one or more flow control devices of the tempering air injection system and to one or more sensors configured to enable the control system to monitor a parameter of the exhaust gas within the exhaust duct assembly, wherein the control system is configured to adjust an amount of the tempering air used to cool the exhaust gas in response to detecting a change in the monitored parameter of the exhaust gas.

13. The gas turbine system of claim 8, comprising a control system communicatively coupled to one or more flow control devices of the tempering air injection system, wherein the control system is configured to monitor loading of the gas turbine engine, and to adjust an amount of the tempering air used to cool the exhaust gas in response to detecting a change in the loading of the gas turbine engine or ambient air conditions.

14. A system, comprising:
an exhaust duct assembly configured to receive exhaust gas from a gas turbine engine;
an absorption chiller fluidly coupled to the exhaust duct assembly and configured to receive a take-off stream of exhaust gas from the exhaust duct assembly via an exhaust take-off path, wherein the absorption chiller is configured to use the take-off stream of exhaust gas to drive at least a portion of an absorption cooling process to generate a cooled take-off stream of exhaust gas; and
a heat exchanger fluidly coupled to the absorption chiller via a chilled fluid path configured to flow a stream of chilled fluid from the absorption chiller to the heat exchanger, wherein the heat exchanger is positioned within the exhaust duct assembly or is part of a tempering air injection system configured to provide tempering air to the exhaust duct assembly.

15. The system of claim 14, wherein the absorption chiller comprises a generator section having a generator heat exchanger, wherein the generator heat exchanger is fluidly coupled to the exhaust duct assembly by a take-off flow path such that the generator heat exchanger is configured to receive the take-off stream of exhaust gas and place the take-off stream of exhaust gas in heat exchange with a dilute absorber solution to produce the cooled take-off stream of exhaust gas and a concentrated absorber solution.

16. The system of claim 14, comprising a flow control system positioned along the chilled fluid path configured to split the stream of chilled fluid between the heat exchanger, the heat exchanger being part of the tempering air system, and an exhaust gas heat exchanger positioned within the exhaust duct assembly.

17. The system of claim 16, comprising a control system communicatively coupled to at least a portion of the flow control system, wherein the control system is configured to control the split of the stream of chilled fluid to control an amount of the stream of chilled fluid provided to the heat exchanger versus an amount of the stream of chilled fluid provided to the exhaust gas heat exchanger.

18. The system of claim 17, wherein the control system is configured to control the split based on loading of the gas turbine engine, based on ambient air conditions, based on a sensed temperature of exhaust gas within the exhaust duct assembly, or any combination thereof.

19. A gas turbine system, comprising:
a gas turbine engine configured to combust a fuel and produce an exhaust gas;
an exhaust duct assembly fluidly coupled to the gas turbine engine and configured to receive the exhaust gas from the gas turbine engine, wherein the exhaust duct assembly is configured to flow the exhaust gas along an exhaust gas path from an inlet to an outlet;
a selective catalytic reduction (SCR) system having an SCR catalyst positioned within the exhaust duct assembly and an ammonia injection grid positioned within the exhaust duct assembly upstream of the SCR catalyst, wherein the ammonia injection grid is configured to inject ammonia into the exhaust gas path and the SCR catalyst is configured to reduce an amount of NOₓ present within the exhaust gas;
an absorption chiller fluidly coupled to the exhaust duct assembly and configured to receive a take-off stream of exhaust gas from the exhaust duct assembly via an exhaust take-off path, wherein the absorption chiller is configured to use the take-off stream of exhaust gas to drive at least a portion of an absorption cooling process to generate a cooled take-off stream of exhaust gas, wherein the exhaust duct assembly is configured to receive the cooled take-off stream of exhaust gas from the absorption chiller via a cooled take-off path and to mix the cooled take-off stream of exhaust gas with exhaust gas along the exhaust flow path to cool the exhaust gas; and
a control system configured to control cooling of the exhaust gas along the exhaust gas path such that a temperature of the exhaust gas, upon encountering the SCR catalyst, is within a predetermined temperature range that is appropriate for the SCR catalyst to reduce the amount of NOₓ present within the exhaust gas.

20. The gas turbine system of claim 19, comprising a heat exchanger fluidly coupled to the absorption chiller via a chilled fluid path configured to flow a stream of chilled fluid from the absorption chiller to the heat exchanger, wherein the heat exchanger is positioned within the exhaust duct assembly or is part of a tempering air injection system configured to provide tempering air to the exhaust duct assembly, and wherein the control system is configured to control cooling of the exhaust gas by controlling at least a flow of the stream of chilled fluid to the heat exchanger and to control a flow of the take-off stream to the absorption chiller.
